(19) United States
(12) Patent Application Publication
(10) Pub. No.: US 2017/0371528 A1
(43) Pub. Date: Dec. 28, 2017

(54) APPARATUS AND METHOD FOR MANAGING NAVIGATION ON INDUSTRIAL OPERATOR CONSOLE USING TOUCHSCREEN

(71) Applicant: Honeywell International Inc., Morris Plains, NJ (US)

(72) Inventors: David James Cupitt, Seaforth (AU); Andrew Stuart, Narrabeen (AU); Graeme Laycock, Hunters Hill (AU); Thomas Street, Meadowbank (AU)

(21) Appl. No.: 15/190,376

(22) Filed: Jun. 23, 2016

(51) Int. Cl. G06F 3/0484; G06F 3/14; G06F 3/0488; G09G 5/14; G06F 3/041

(52) U.S. Cl. CPC G06F 3/04847; G09G 5/14; G06F 3/0416; G06F 3/04883; G06F 3/04886; G06F 3/0412; G06F 3/1446; G09G 2320/0606; G09G 2320/10; G09G 2340/14; G09G 2354/00

(57) ABSTRACT

A method includes presenting a representation of a multi-panel display of an operator console on a touchscreen separate from the multi-panel display. The representation includes multiple placeholders associated with multiple panels of the multi-panel display. The method also includes receiving user input via the touchscreen, where the user input identifies at least one of the placeholders associated with at least one of the panels and a desired function. The method further includes performing the desired function to one of change first content presented in the at least one panel or change second content presented on the touchscreen based on the first content presented in the at least one panel. The desired function could include pushing the first content to the at least one panel or pulling the second content from the at least one panel.

### TECHNICAL FIELD

This disclosure relates generally to industrial process control and automation systems. More specifically, this disclosure relates to an apparatus and method for managing navigation on an industrial operator console using a touchscreen.

### BACKGROUND

Industrial process control and automation systems are often used to automate large and complex industrial processes. These types of systems routinely include sensors, actuators, and controllers. Some of the controllers receive measurements from the sensors and generate control signals for the actuators. Other controllers perform higher-level functions, such as planning, scheduling, and optimization operations.

These types of control and automation systems also typically include numerous operator consoles. Operator consoles are often used to receive inputs from operators, such as setpoints for process variables in an industrial process being controlled. Operator consoles are also often used to provide outputs to operators, such as to display warnings, alarms, or other information associated with the industrial process being controlled. Large collections of operator consoles are often used in control rooms where a number of operators assemble and work.

### SUMMARY

This disclosure provides an apparatus and method for managing navigation on an industrial operator console using a touchscreen.

In a first embodiment, a method includes presenting a representation of a multi-panel display of an operator console on a touchscreen separate from the multi-panel display. The representation includes multiple placeholders associated with multiple panels of the multi-panel display. The method also includes receiving user input via the touchscreen, where the user input identifies at least one of the placeholders associated with at least one of the panels and a desired function. The method further includes performing the desired function to one of change first content presented in the at least one panel or change second content presented on the touchscreen based on the first content presented in the at least one panel.

In a second embodiment, an apparatus includes a touch-sensitive display and at least one processing device. The at least one processing device is configured to present a representation of a multi-panel display of an operator console on the touch-sensitive display. The representation includes multiple placeholders associated with multiple panels of the multi-panel display. The touch-sensitive display is configured to receive user input identifying at least one of the placeholders associated with at least one of the panels and a desired function. The at least one processing device is configured to perform the desired function to one of change first content presented in the at least one panel or change second content presented on the touch-sensitive display based on the first content presented in the at least one panel.

In a third embodiment, a system includes an operator console having at least one display device configured to present a multi-panel display to at least one user, where the multi-panel display includes multiple panels. The system also includes a touchscreen device separate from the at least one display device. The touchscreen device is configured to present a representation of the multi-panel display, where the representation includes multiple placeholders associated with the multiple panels of the multi-panel display. The touchscreen device is also configured to receive user input identifying at least one of the placeholders associated with at least one of the panels and a desired function. The touchscreen device is further configured to perform the desired function to one of change first content presented in the at least one panel or change second content presented on the touchscreen device based on the first content presented in the at least one panel.

In a fourth embodiment, a non-transitory computer readable medium contains instructions that, when executed by at least one processing device of a touchscreen separate from a multi-panel display of an operator console, causes the at least one processing device to present a representation of the multi-panel display on the touchscreen. The representation includes multiple placeholders associated with multiple panels of the multi-panel display. The medium also contains instructions that, when executed by the at least one processing device, causes the at least one processing device to receive user input via the touchscreen. The user input identifies at least one of the placeholders associated with at least one of the panels and a desired function. The medium further contains instructions that, when executed by the at least one processing device, causes the at least one processing device to perform the desired function to one of change first content presented in the at least one panel or change second content presented on the touchscreen based on the first content presented in the at least one panel.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIGS. 2 through 4 illustrate example operator consoles and related details according to this disclosure;

FIG. 5 illustrates an example multi-panel display for presentation on an operator console according to this disclosure;

FIGS. 6A and 6B illustrate an example display for presentation on a touchscreen of an operator console according to this disclosure; and

FIGS. 7 and 8 illustrate example methods for managing navigation on an industrial operator console using a touchscreen according to this disclosure.

### DETAILED DESCRIPTION

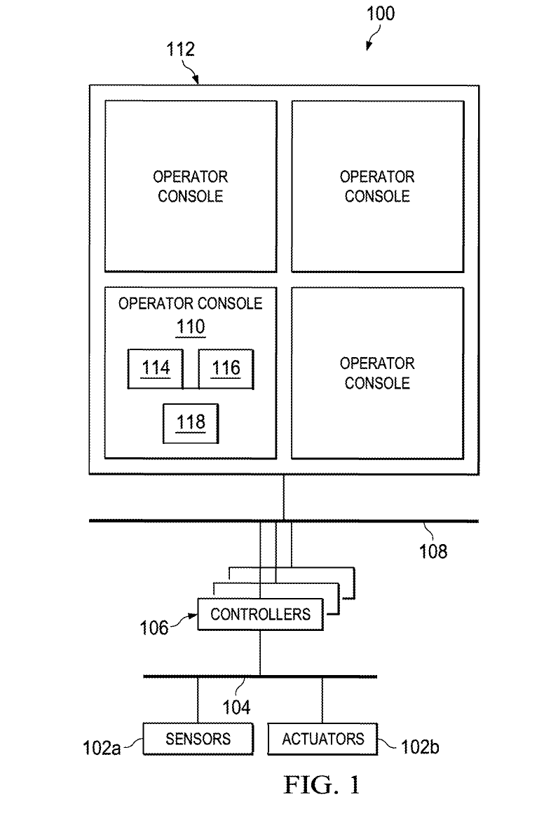

FIGS. 1 through 8, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network, electrical signal network (such as a HART or FOUNDATION FIELDBUS network), pneumatic control signal network, or any other or additional type(s) of network(s).

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control or other advanced predictive control. As a particular example, each controller 106 could represent a computing device running a real-time operating system, a WINDOWS operating system, or other operating system.

Operator access to and interaction with the controllers 106 and other components of the system 100 can occur via various operator consoles 110. As described above, each operator console 110 could be used to provide information to an operator and receive information from an operator. For example, each operator console 110 could provide information identifying a current state of an industrial process to the operator, such as values of various process variables and warnings, alarms, or other states associated with the industrial process. Each operator console 110 could also receive information affecting how the industrial process is controlled, such as by receiving setpoints or control modes for process variables controlled by the controllers 106 or other information that alters or affects how the controllers 106 control the industrial process.

Multiple operator consoles 110 can be grouped together and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

Each operator console 110 includes any suitable structure for displaying information to and interacting with an operator. For example, each operator console 110 could include one or more processing devices 114, such as one or more processors, microprocessors, microcontrollers, field programmable gate arrays, application specific integrated circuits, discrete logic devices, or other processing or control devices. Each operator console 110 could also include one or more memories 116 storing instructions and data used, generated, or collected by the processing device(s) 114. Each operator console 110 could further include one or more network interfaces 118 that facilitate communication over at least one wired or wireless network, such as one or more Ethernet interfaces or wireless transceivers.

Human operators are typically responsible for managing industrial processes and often need to act quickly and efficiently to maintain safe and profitable operations of industrial plants. To do this, operators are often constantly engaged in a process of orienting themselves to the current state of an industrial process, evaluating whether the current state requires human intervention, and (if so) performing the interventions and assessing the outcomes of the interventions.

A conventional operator console supporting these functions typically includes one or more display screens and one or more keyboards and pointing devices, such as mice or trackballs. Unfortunately, this arrangement often requires operators to divide their attention between the visualization of process information on the display screens (which are often oriented substantially vertically) and user input devices (which are often located on substantially horizontal work surfaces). For example, changing a process parameter often involves an operator selecting the parameter on a display screen using a mouse, finding and pressing the relevant keys on a keyboard, and viewing the results on the display screen. Because of this, operators often need to look back and forth between their display screens and their user input devices, and the operators often need to move their hands back and forth between different input devices in order to change process parameters. Divided attention and the need to switch between input devices make the overall process less efficient than it could be.

In accordance with this disclosure, an operator console 110 includes or operates in conjunction with a touchscreen. The touchscreen combines the visualization of process information with a mechanism for interacting with that information. The touchscreen also supports a mechanism for moving content between the touchscreen and at least one other display screen of the operator console 110. The touchscreen further allows for the management of where content being moved from the touchscreen is placed on the at least one other display screen, as well as management of which content on the at least one other display screen is moved to the touchscreen.

Although FIG. 1 illustrates one example of an industrial process control and automation system 100, various changes may be made to FIG. 1. For example, industrial control and automation systems come in a wide variety of configurations. The system 100 shown in FIG. 1 is meant to illustrate one example operational environment in which touchscreens can be incorporated into or used with operator consoles. FIG. 1 does not limit this disclosure to any particular configuration or operational environment.

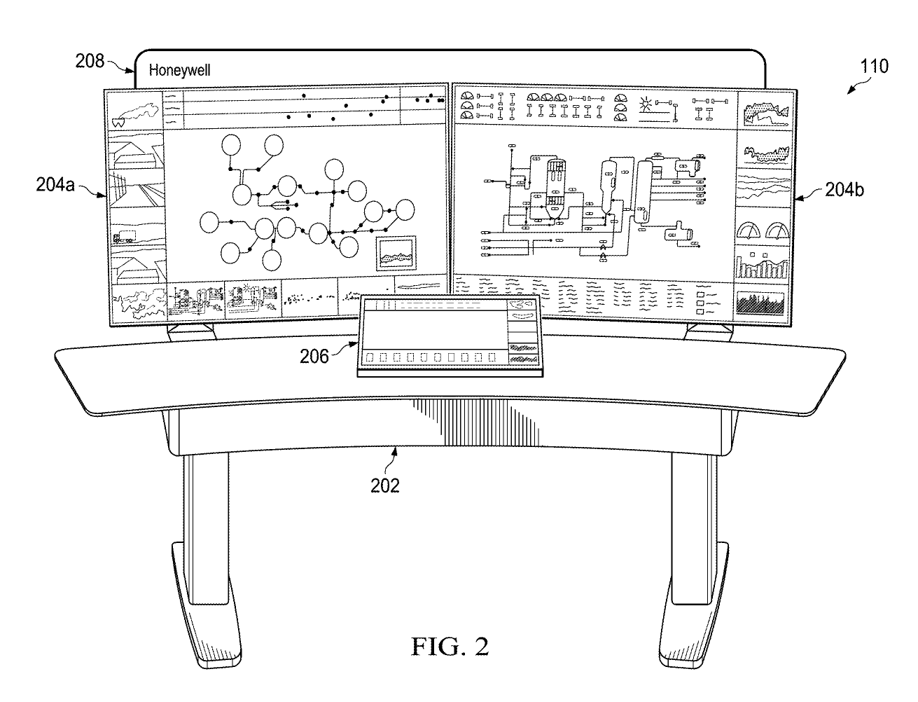

FIGS. 2 through 4 illustrate example operator consoles 110 and related details according to this disclosure. As shown in FIG. 2, one example of the operator console 110 is positioned on a desk 202. The desk 202 supports components of the operator console 110 and could be used to hold or retain electronics of the operator console 110. For example, a computing device that includes the components 114-118 could be retained (and possibly hidden) under the desk 202.

The operator console 110 includes one or more display screens 204a-204b placed on, mounted to, or otherwise associated with the desk 202. The display screens 204a-204b can be used to present various information to an operator. For instance, the display screens 204a-204b could be used to present human-machine interface (HMI) displays that include diagrams of an industrial process being controlled and information associated with the current state of the industrial process being controlled. The HMI displays could also be used to receive information from an operator. Each display screen 204a-204b includes any suitable display device, such as a liquid crystal display (LCD) device or a light emitting diode (LED) display device. In this example, there are two display screens 204a-204b adjacent to and angled with respect to one another. However, an operator console 110 could include a single display screen or multiple display screens in any suitable arrangement.

The operator console 110 in this example also includes a touchscreen 206. The touchscreen 206 here is placed on the desk 202 and can be positioned at an angle, such as about 15° to about 35° . The angle of the touchscreen 206 could be adjustable. The touchscreen 206 can be used to interact with the HMI displays presented on the display screens 204a-204b and to control the content on the display screens 204a-204b. The touchscreen 206 could also present additional HMI displays and other information not presented on the display screens 204a-204b. The touchscreen 206 includes any suitable display device with touch sensitivity, such as an LCD or LED touchscreen.

The operator console 110 further includes an ambient display 208, which in this example is positioned at the top of the display screens 204a-204b. The ambient display 208 can output light having different characteristic(s) to identify the current status of an industrial process (or portion thereof) being monitored or controlled using the operator console 110. For example, the ambient display 208 could output green light or no light when the current status of an industrial process or portion thereof is normal. The ambient display 208 could output yellow light when the current status of an industrial process or portion thereof indicates that a warning has been issued. The ambient display 208 could output red light when the current status of an industrial process or portion thereof indicates that an alarm has been issued. Note that other or additional characteristics of the ambient light can also be controlled, such as the intensity of light or the speed of transitions in the light. The ambient display 208 here represents an edge-lit glass segment or other clear segment, where one or more edges of the segment can be illuminated using an LED strip or other light source. Note, however, that the use of the ambient display 208 is optional.

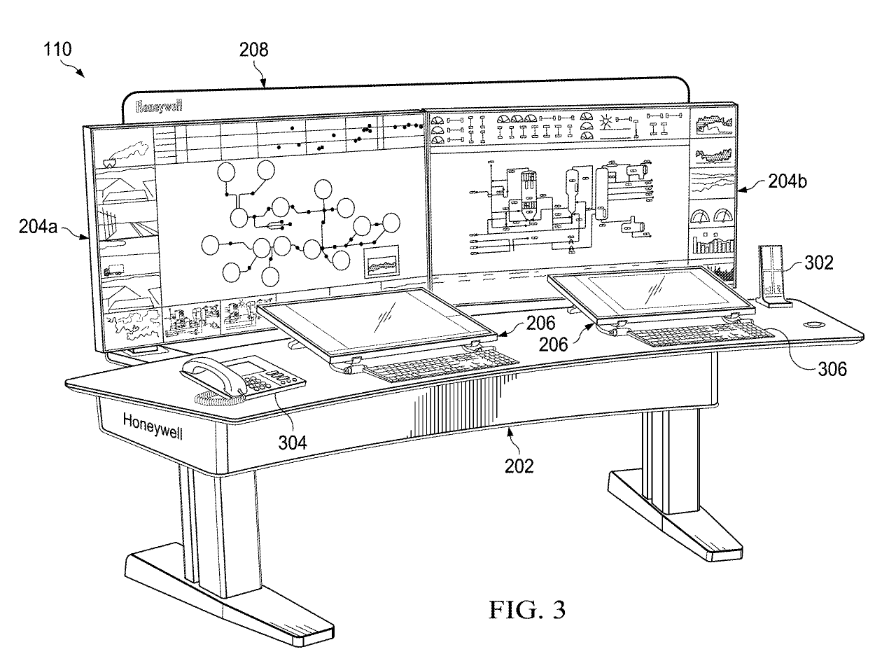

As shown in FIG. 3, another example of the operator console 110 is positioned on the desk 202 and includes the display screens 204a-204b and the ambient display 208. The operator console 110 in this example also includes multiple instances of the touchscreen 206, where each touchscreen 206 is associated with a different display screen 204a-204b.

The operator console 110 in this example also includes at least one mobile device 302. The mobile device 302 can be used to support interactions between an operator and HMI displays presented on the display screens 204a-204b. For example, the mobile device 302 could include a touchscreen that can be used to control the content on the display screens 204a-204b and to interact with the HMI displays presented on the display screens 204a-204b. Moreover, the mobile device 302 could receive and display information to an operator, such as current process variable values or process states, when the operator moves away from the operator console 110. The mobile device 302 includes any suitable device that is mobile and that supports interaction with an operator console, such as a tablet computer or smartphone. Note, however, that the use of the mobile device(s) 302 is optional.

The operator console 110 in this example further includes one or more desktop telephones 304 and one or more keyboards 306. Each desktop telephone 304 could represent any suitable analog or digital telephone. Each keyboard 306 includes any suitable structure for providing physical keys that can be depressed by an operator. Note, however, that the use of the desktop telephone(s) 304 and the keyboard(s) 306 is optional.

As an alternative to conventional operator console interfaces, the operator consoles 110 shown in FIGS. 2 and 3 combine both visualizing and interacting with industrial processes within one user interface device (a touchscreen 206). The touchscreen 206 features high-resolution graphics for visualization and touchscreen technology for interaction. The touchscreen 206 presents process visualizations that allow direct touch gesture interactions. Example operations that could be triggered using the touchscreen 206 include navigating information in a display (such as scrolling a trend) and manipulating process parameters (such as changing a setpoint). An operator can manipulate visualizations directly with touch gestures on the touchscreen 206 rather than using separate input devices like a keyboard and a mouse/trackball.

Any suitable touch gestures could be supported by the touchscreen 206, such as discrete tapping gestures to select pre-defined values presented on the touchscreen 206 and continuous sliding, dragging, or pinching gestures to select values from a continuous range. Examples of these types of touch gestures are described more fully in U.S. patent application Ser. No. 14/487,276 filed on Sep. 16, 2014 (which is hereby incorporated by reference in its entirety). As another example, the touchscreen 206 can support a mechanism to easily move content between the touchscreen 206 and one or more display screens 204a-204b (or vice versa) using the touchscreen 206. These “content management” operations could include selecting a panel or other area of a display screen 204a-204b using the touchscreen 206 and pushing a selected HMI display (which may or may not be currently presented on the touchscreen 206) to the selected area of the display screen 204a-204b. These “content management” operations could also include selecting a panel or other area of a display screen 204a-204b using the touchscreen 206 and pulling the HMI display in the selected area onto the touchscreen 206.

The ergonomically-sound arrangement of the touchscreens 206 and the direct manipulation interfaces allow operators to work more effectively and efficiently over long periods of time. All touch-based data entry operations can be optimized for efficiency and safety to exclude inaccurate or accidental inputs. Moreover, the operator consoles 110 allow operators to efficiently bring HMI displays onto the touchscreens 206 or display screens 204a-204b for direct interaction or viewing without having to divide their attention or move their hands between different input devices.

In particular embodiments, a touchscreen 206 can be driven by a computing device (either within the touchscreen 206 or external to the touchscreen 206), and the display(s) 204a-204b could be driven by a separate computing device (such as one containing the components 114-118). This could provide a form of fault tolerance in an operator console 110. That is, if the computer driving the display(s) 204a-204b fails, the touchscreen 206 could still be used to maintain control over an industrial process (or vice versa). Note that a keyboard 306 could be provided in a hidden or other storage location that is accessible if and when the touchscreen 206 of an operator console 110 fails.

Also, in particular embodiments, an operator console 110 could be implemented using a modified form of the EXPERION HMI platform from HONEYWELL INTERNATIONAL INC. The modifications can include modifications enabling safe and reliable touch-based interaction with HMI displays, modifications enabling the movement of content between screens of a console, and modifications controlling which content is moved between screens of a console.

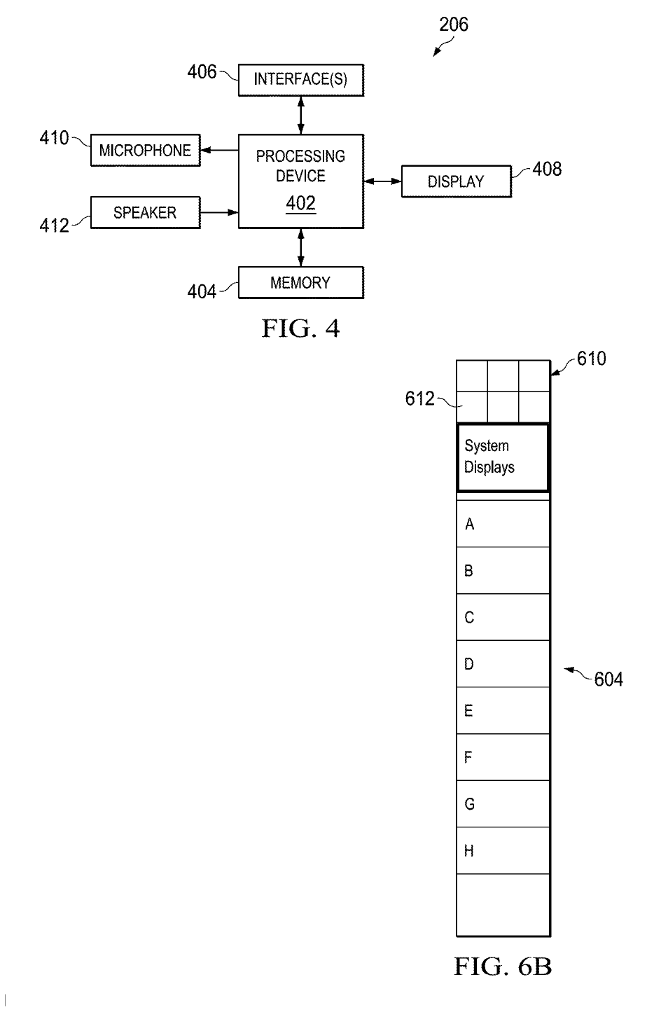

As shown in FIG. 4, a touchscreen 206 includes at least one processing device 402, which controls the overall operation of the touchscreen 206. For example, the processing device 402 may control interactions with an operator console 110, such as by identifying gestures related to displaying, changing, or moving content on one or more display screens 204a-204b of the operator console 110. The processing device 402 may also control interactions with an external control system, such as by identifying gestures related to retrieving process variable values or other content from the control system and changing process variable values or other content that is delivered to the control system. As noted above, the operator console 110 could include a separate computing device (such as the components 114-118), and the processing device 402 of the touchscreen 206 could interact with the separate computing device to control or modify the contents on the one or more display screens 204a-204b. The processing device 402 includes any suitable structure for controlling the operation of a touchscreen. As particular examples, the processing device 402 could include one or more processors, microprocessors, microcontrollers, field programmable gate arrays, application specific integrated circuits, discrete logic devices, or other processing or control devices.

At least one memory 404 stores any of a wide variety of information used, collected, or generated by the touchscreen 206. For example, the memory 404 could store instructions executed by the processing device(s) 402, as well as data transmitted to or received from the operator console 110 and data received from an operator. The memory 404 includes any suitable volatile and/or non-volatile storage and retrieval device or devices.

At least one interface 406 supports interaction with external devices or systems, such as a computing device within the operator console 110 or an external control system. Each interface 406 includes any suitable structure supporting communications over physical or wireless paths. For example, a touchscreen 206 could include a wired USB, FIREWIRE, THUNDERBOLT, Ethernet, or other physical connection(s) to an operator console or other devices. A touchscreen 206 could also or alternatively include a wireless WIFI, BLUETOOTH, or other wireless connection to an operator console or other devices. Any number of interfaces 406 could be supported.

The touchscreen 206 further includes a display 408. The display 408 represents a touch-sensitive display for presenting text, images, or other data to an operator and receiving inputs from an operator. The display 408 includes any suitable touch-sensitive display, such as an LCD or LED touchscreen.

Depending on the implementation, the touchscreen 206 could include various other components, such as a microphone 410 and a speaker 412. The microphone 410 can be used to capture audio information, such as voice communications from an operator. The speaker 412 can be used to generate audio information, such as audible alarms or voice information received from another operator engaging in a voice communication session with the touchscreen 206.

A touchscreen 206 could support various other functions as needed or desired. For instance, the touchscreen 206 could be portable, and the processing device(s) 402 of the touchscreen 206 could interact with the computing device coupled to the display screen(s) 204a-204b of an operator console 110, such as when the touchscreen 206 is moved to within a specified distance of or physically docks with the operator console 110. The touchscreen 206 could do this each time the touchscreen 206 is moved to a different operator console 110, and information stored in the touchscreen 206 or elsewhere could be used to update a specific operator console 110 each time the touchscreen 206 interfaces with that specific operator console 110.

Although FIGS. 2 through 4 illustrate examples of operator consoles 110 and related details, various changes may be made to FIGS. 2 through 4. For example, an operator console 110 could have any combination of the features shown in FIGS. 2 and 3, such as when a feature shown in one figure is used in another figure. Also, various components in FIGS. 2 through 4 could be combined, subdivided, or omitted and additional components could be added according to particular needs. As a particular example, the processing device 402 could be implemented using a central processing unit (CPU) and a graphics processing unit (GPU). In addition, an operator console 110 could include any number of display devices and touchscreens, with any suitable association between the display devices and touchscreens.

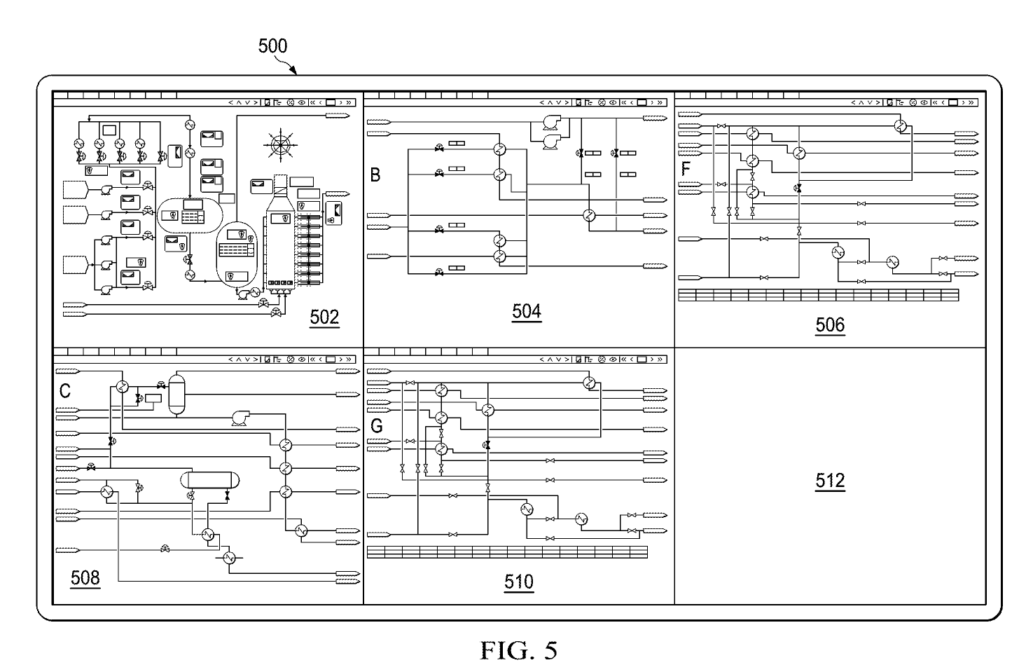

FIG. 5 illustrates an example multi-panel display 500 for presentation on an operator console according to this disclosure. For example, the multi-panel display 500 could be presented on at least one of the display screens 204a-204b of the operator console 110. As shown in FIG. 5, the multi-panel display 500 includes multiple separate panels 502-512 in which different content can be presented to one or more users. For instance, each of the panels 502-512 can be used to present an HMI display to one or more operators. As a particular example, each HMI display could graphically represent all or a portion of an industrial process and provide data related to the displayed industrial process, such as process variable values or notifications (like warnings or alarms).

In this example, there are six panels 502-512 arranged in two rows and three columns, each of the panels 502-512 is rectangular, and all panels 502-512 have the same size and shape. This is for illustration only. Other numbers and arrangements of panels could be used on one or more display screens 204a-204b. Also, each of the panels could have any suitable size and shape, and the panels may or may not be identical in size or shape. In addition, the number and sizes of panels could vary, such as when fewer panels of larger size or more panels of smaller size can be presented.

In the example shown in FIG. 5, only five panels 502-510 currently contain HMI displays, while the sixth panel 512 does not include an HMI display. This means, for example, that a user could use a touchscreen 206 to select an HMI display for presentation in the panel 512. Note that while shown as being blank here, one or more messages could be presented to a user in the panel 512. For instance, based on the user currently logged into an operator console 110 and the responsibilities of that user or based on the current status of an industrial process, the panel 512 could present a note indicating that the user should select a particular HMI display or type of HMI display for presentation in the panel 512 or another panel 502-510.

In some embodiments, the panels 502-512 shown in FIG. 5 could be presented on a single display screen, and the layout of panels 502-512 shown in FIG. 5 could be replicated across multiple display screens of an operator console 110. In the examples shown in FIGS. 2 and 3, this allows the operator console 110 to present up to twelve different HMI displays to one or more operators simultaneously. The one or more operators could then use one or more touchscreens 206 to control the content that is presented in the various panels as described below.

Although FIG. 5 illustrates one example of a multi-panel display 500 for presentation on an operator console, various changes may be made to FIG. 5. For example, a display screen 204a or 204b could include multiple panels in any suitable arrangement. Also, the actual contents of the panels 502-512 in FIG. 5 are for illustration only, and any other or additional types of content could be presented on the multi-panel display 500.

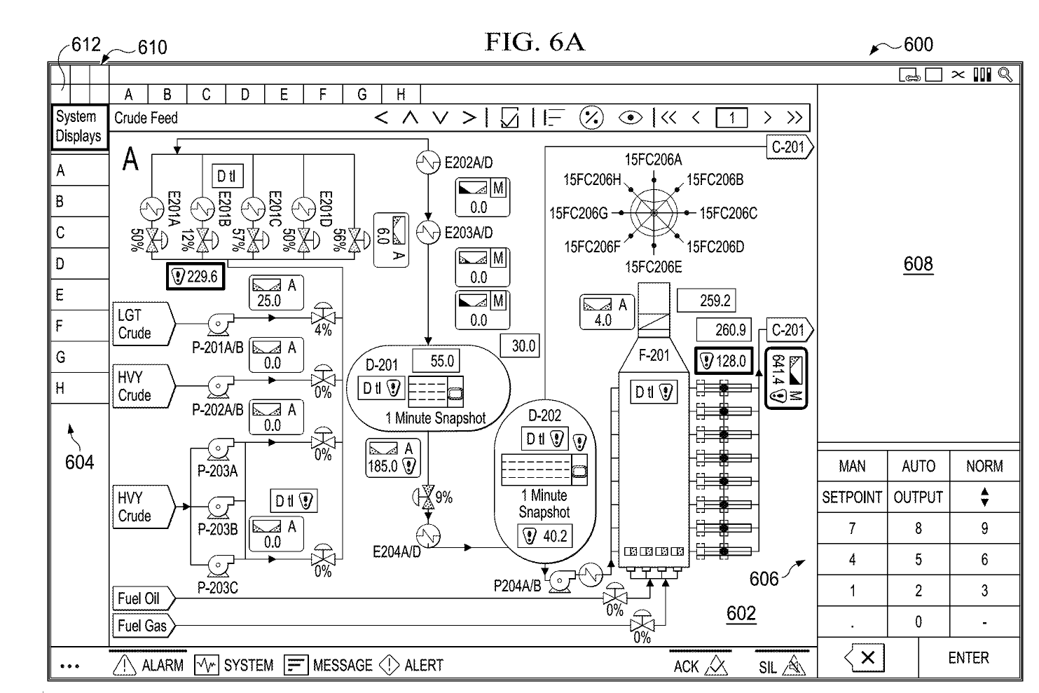

FIGS. 6A and 6B illustrate an example display 600 for presentation on a touchscreen of an operator console according to this disclosure. In particular, FIGS. 6A and 6B illustrate an example display 600 for a touchscreen 206 that can be used to select content for and move content to and from the panels 502-512 of the multi-panel display 500 in FIG. 5. However, a touchscreen 206 could be used with any other suitable multi-panel display.

As shown in FIG. 6A, the display 600 includes an HMI display area 602 in which at least one HMI display can be presented to a user. The HMI display area 602 in FIG. 6A currently contains an HMI display that could be used by a user to review the operational status of an industrial process or make changes to the industrial process. As particular examples, the user could review any warnings or alarms associated with the industrial process or modify setpoints, control modes, or other values of process variables associated with the industrial process.

Any suitable mechanism could be supported allowing a user to select one or more HMI displays for presentation in the HMI display area 602. In this example, a list 604 is presented to the user, where the list 604 identifies various HMI displays that could be selected by the user. More specifically, the list 604 in this example contains eight different HMI displays identified by letter, any of which could be selected by the user. The HMI displays available for selection could be identified in any suitable manner, such as based on the specific user or user role of the operator currently using the operator console 110. Of course, the list 604 could contain any number of HMI displays for selection, and the HMI displays could be identified in other ways, such as with more detailed descriptions of the HMI displays' contents. Also note that other mechanisms besides a list could be used to select an HMI display. For instance, a hierarchical arrangement of equipment in an industrial process (with different equipment associated with different HMI displays) could be navigated to select a specific HMI display.

An input area 606 provides controls allowing users to enter data through touch input, such as for the HMI display currently presented in the HMI display area 602. For example, a user could select a process variable identified in the HMI display area 602 and alter a value for that process variable using the numerical and up/down buttons in the input area 606. SETPOINT and OUTPUT buttons allow the user to define an output (OP) value or a setpoint value (SP) for a selected process variable. The user could also select a process variable identified in the HMI display area 602 and change the control mode for that process variable using the MAN, AUTO, or NORM buttons in the input area 606. The MAN button places a selected process variable under manual control. The AUTO button places a selected process variable under automatic control such that its output value is calculated using an operator-defined setpoint. The NORM button places a selected process variable under normal control of an associated process controller 106. Note that these types of input values are examples only and could be based on what inputs might typically be needed for HMI displays to be presented in the HMI display area 602. However, any other or additional controls could be provided in the input area 606 in order to receive input from a user, and the controls in the input area 606 could vary (such as in response to selection of a particular HMI display or type of HMI display for the HMI display area 602).

The display 600 could optionally include at least one additional area 608, which could be used for any suitable purpose(s). For example, the additional area 608 could present information related to a specific HMI display being presented in the HMI display area 602, such as information associated with warnings or alarms for the displayed portion of an industrial process. The additional area 608 could also present additional input controls for a specific process variable selected in the HMI display area 602 or for a specific HMI display presented in the HMI display area 602. The additional area 608 could further present information related to the status of a connection between the touchscreen 206 and the associated operator console 110. In general, any suitable information or controls related to the touchscreen 206, operator console 110, user, industrial process, or other aspects of a system could be presented in the additional area 608.

As noted above, a user can use the touchscreen 206 to push content to, pull content from, or otherwise control the content presented on one or more display screens 204a-204b. In the display 600 shown in FIGS. 6A and 6B, a representation 610 of a multi-panel display is presented to a user, and the representation 610 includes a placeholder 612 for each panel of the multi-panel display. For example, the representation 610 could represent the multi-panel display 500 of FIG. 5, and each placeholder 612 could represent one of the panels 502-510 in the multi-panel display 500 of FIG. 5. The placeholders 612 in the representation 610 can be arranged in the same manner as the corresponding panels are arranged in the multi-panel display. As a result, in this example, the representation 610 includes six placeholders 612 arranged in two rows and three columns to match the layout of the multi-panel display 500. However, the representation 610 could include any number of placeholders 612 in any suitable arrangement depending on the layout and arrangement of the multi-panel display.

The placeholders 612 in the representation 610 can be selected or used in different ways by a user to control the content presented in the panels of a multi-panel display or to control the content presented on the touchscreen 206. For example, different touch inputs can be received by the touchscreen 206 on the placeholders 612 in the representation 610 in order to control the content presented in the panels 502-512 of the associated multi-panel display 500 or on the display 408 of the touchscreen 206.

As one example of a touch input that can be received by the touchscreen 206, assume a user has selected a particular HMI display for presentation within the HMI display area 602. Also assume that the user now wishes for the same HMI display to be presented on (pushed to) a particular panel 502-512 of the multi-panel display 500. In some embodiments, the user could identify the placeholder 612 associated with the particular panel 502-512 of the multi-panel display 500 and touch that placeholder 612 for at least a threshold period of time (such as one second or two seconds). In response to detecting the touch of the particular placeholder 612 for at least the threshold period of time, the processing device 402 of the touchscreen 206 could interact with the processing device 114 of the operator console 110 to cause the particular HMI display to be presented within the particular panel 502-512 of the multi-panel display 500.

In other embodiments, to push an HMI display from the HMI display area 602 to a particular panel 502-512 of a multi-panel display 500, the user could identify the placeholder 612 associated with the particular panel 502-512. The user could then “drag” the HMI display currently being presented in the HMI display area 602 to that placeholder 612. The drag could be performed by the user touching a specific portion or any portion of the HMI display area 602 or the presented HMI display and dragging his or her finger across the display 408 to the particular placeholder 612 in the representation 610. The user could then release or “drop” the HMI display by removing his or her finger from the display 408. In response to detecting the drag and drop, the processing device 402 of the touchscreen 206 could interact with the processing device 114 of the operator console 110 to cause the particular HMI display to be presented within the particular panel 502-512 of the multi-panel display 500.

As another example of a touch input that can be received by the touchscreen 206, assume a user has selected a particular HMI display for presentation within a panel 502-512 of the multi-panel display 500. This could be done, for example, as described above or in any other suitable manner. Also assume that the user now wishes for the same HMI display to be presented on (pulled to) the touchscreen 206. In some embodiments, the user could identify the placeholder 612 associated with the particular panel 502-512. The user could then “drag” the identified placeholder 612 and “drop” the identified placeholder 612 into the HMI display area 602. The drag could be performed by the user touching the identified placeholder 612 and dragging his or her finger across the display 408 to a specific portion or any portion of the HMI display area 602. In response to detecting the drag and drop, the processing device 402 of the touchscreen 206 could interact with the processing device 114 of the operator console 110 to cause the particular HMI display from the multi-panel display 500 to be presented within the HMI display area 602.

As yet another example of a touch input that can be received by the touchscreen 206, assume a user wishes for a particular HMI display to be presented within a panel 502-512 of a multi-panel display 500, but the particular HMI display is not currently being presented within the HMI display area 602 of the display 600. In some embodiments, the user could identify the placeholder 612 associated with the particular panel 502-512 and quickly “tap” the particular placeholder 612. The user could then select a particular HMI display from the list 604 or other data structure identifying HMI displays. Of course, the order of selection of the placeholder and HMI display could be reversed. In response to detecting a placeholder selection and an HMI selection, the processing device 402 of the touchscreen 206 could interact with the processing device 114 of the operator console 110 to cause the particular HMI display to be presented within the particular panel 502-512 of the multi-panel display 500. A user could do this repeatedly for different panels 502-512 of the multi-panel display 500 in order to quickly populate most or all of the multi-panel display 500 with different HMI displays.

As still another example of a touch input that can be received by the touchscreen 206, assume a user wishes for multiple HMI displays to be presented within multiple panels 502-512 of a multi-panel display 500. The user could select multiple HMI displays from the list 604 or other data structure identifying HMI displays, such as by swiping left or right on specific HMI displays identified in the list 604. The user could then select a particular placeholder 612 within the representation 610 for a particular panel 502-512 of the multi-panel display 500, where the selected HMI displays will be presented starting with the selected panel and moving in some pattern (such as clockwise, counterclockwise, left-to-right, or up-down). The processing device 402 of the touchscreen 206 could then interact with the processing device 114 of the operator console 110 to cause the particular HMI displays to be presented.

As a final example of a touch input that can be received by the touchscreen 206, assume a user wishes for multiple HMI displays to be sequentially presented within a single panel 502-512 of a multi-panel display 500. The sequence of HMI displays could be predefined (such as the entire set of HMI displays identified in the list 604), or the HMI displays could be selected from the list 604 or other data structure identifying HMI displays. The user could then select a particular placeholder 612 within the representation 610 for a particular panel 502-512 of the multi-panel display 500, such as by double-tapping the selected representation 610. The processing device 402 of the touchscreen 206 could then interact with the processing device 114 of the operator console 110 to cause the particular HMI displays to be presented in the identified panel 502-512 of the multi-panel display 500.

Note that the above examples are merely illustrative of how a representation 610 of a multi-panel display 500 could be used on a touchscreen 206 to move content to or from the multi-panel display 500 or to control the content on the multi-panel display 500 or touchscreen 206. There may be numerous other ways in which taps, swipes, or other gestures can be used with a representation 610 of a multi-panel display 500. The above examples are provided for illustration only, and any specific implementation of an operator console 110 could use any combination of gestures (whether or not described above) in conjunction with a representation 610 of a multi-panel display 500. Other example functions that could be supported using touch gestures on the touchscreen 206 could include clearing a selected panel (identified using a placeholder 612) of a multi-panel display, clearing all panels of a multi-panel display, and causing content on one panel of a multi-panel display to move to another panel of the multi-panel display.

In some embodiments, upon selection of a placeholder 612 in the representation 610, the selected placeholder 612 could change color or pattern or otherwise change to indicate that it has been selected. This may allow a user to verify whether the proper placeholder 612 has been selected and, if not, to reselect an appropriate placeholder 612. FIG. 6B contains an example of this, where the bottom right placeholder 612 has changed color or pattern upon being selected by a user.

Although FIGS. 6A and 6B illustrate one example of a display 600 for a touchscreen of an operator console, various changes may be made to FIGS. 6A and 6B. For example, the content, layout, and arrangement of the display 600 are for illustration only. Content can be added, removed, or rearranged in any suitable manner according to particular needs. Also, while various input mechanisms (such as buttons and lists) are described above, a touchscreen 206 could support any suitable mechanisms for receiving input from a user.

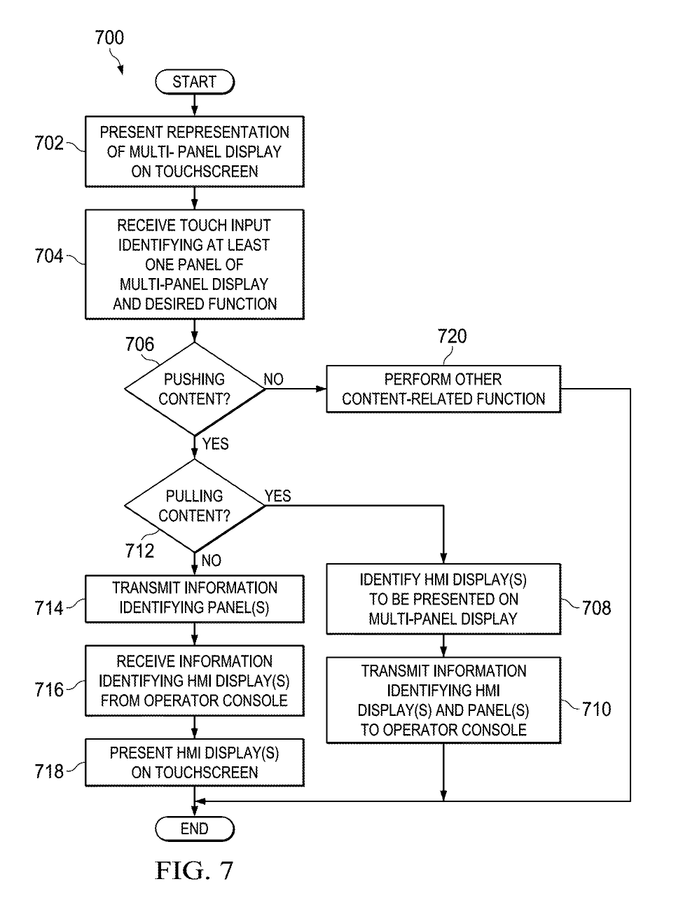

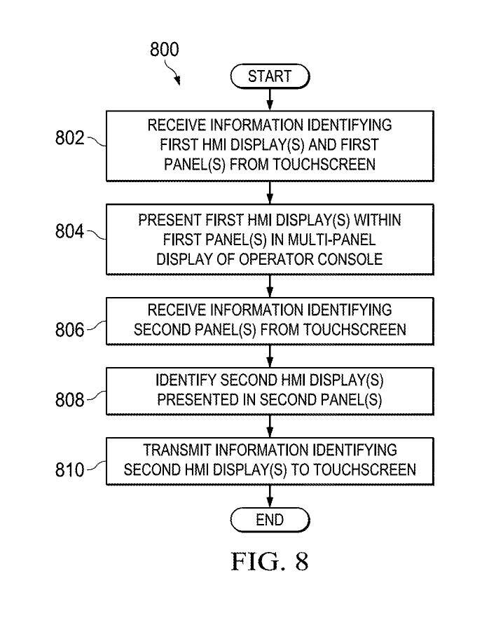

FIGS. 7 and 8 illustrate example methods for managing navigation on an industrial operator console using a touchscreen according to this disclosure. In particular, FIG. 7 illustrates an example method 700 that could be performed by a touchscreen 206, and FIG. 8 illustrates an example method 800 that could be performed by an operator console 110. For ease of explanation, the methods 700 and 800 are described with respect to the operator console 110 and touchscreen 206 of FIGS. 2 through 4, the multi-panel display 500 of FIG. 5, and the touchscreen display 600 of FIG. 6. However, the methods 700 and 800 could be used with any suitable operator console, touchscreen, multi-panel display, and touchscreen display.

As shown in FIG. 7, a representation of a multi-panel display is presented on a touchscreen at step 702. This could include, for example, the processing device 402 of the touchscreen 206 causing the display 408 to present the representation 610 with desired placeholders 612 in an appropriate pattern. The pattern can be based on the possible arrangement of panels in the multi-panel display, such as when the multi-panel display 500 includes panels 502-512 in a 2×3 pattern and the representation 610 includes six placeholders 612 in the same arrangement.

At least one touch input identifying at least one panel of the multi-panel display and a desired function is received at step 704. This could include, for example, the processing device 402 detecting one or more specific gestures, such as specific taps, drags, or drops, on the display 408. At least one of the touch inputs involves one or more of the placeholders 612, thereby providing a selection of one or more of the panels 502-512 in the multi-panel display 500. As noted above, different touch inputs (such as different gestures) could correspond to different functions, such as pushing content to or pulling content from one or more panels 502-512 of the multi-panel display 500.

If it is determined that the desired function involves pushing content at step 706, one or more HMI displays to be presented on the multi-panel display are identified at step 708. Also, information identifying the panel(s) and the HMI display(s) is transmitted to an operator console at step 710. This could include, for example, the processing device 402 identifying one or more of the panels 502-512 of the multi-panel display 500 based on one or more user gestures involving one or more placeholders 612. As particular examples, this could include the processing device 402 identifying one of the placeholders 612 tapped by the user or identifying one of the placeholders 612 to which the user dragged an HMI display being presented in the HMI display area 602. This could also include the processing device 402 of the touchscreen 206 sending information identifying the panel(s) and the HMI display(s) to the processing device 114 of the operator console 110 so that the processing device 114 can cause the operator console 110 to present the identified HMI display(s) on the identified panel(s).

Otherwise, if it is determined that the desired function involves pulling content at step 712, information identifying one or more panels of a multi-panel display is transmitted to an operator console at step 714. Information identifying one or more HMI displays presented in the identified panel(s) is received from the operator console at step 716, and the one or more HMI displays are presented on the touchscreen at step 718. This could include, for example, the processing device 402 identifying one of the placeholders 612 tapped, dragged, or otherwise selected by the user. This could also include the processing device 402 of the touchscreen 206 sending information identifying the panel(s) to the processing device 114 of the operator console 110 so that the processing device 114 can identify the HMI display(s) currently presented on the identified panel(s). This could further include the processing device 402 using the identity of the HMI display(s) to retrieve necessary information from the operator console 110, a control system, or other source(s) of information for presentation within the HMI display area 602.

Otherwise, some other content-related function could be performed at step 720. Any other suitable content-related function could be supported using a touchscreen, such as clearing one or more panels 502-512 of the multi-panel display 500 or swapping HMI displays presented in multiple panels 502-512.

As shown in FIG. 8, the operator console can perform functions corresponding to the touchscreen operations described above. For example, during a push operation, information identifying one or more first HMI displays and one or more first panels is received from a touchscreen at step 802. The one or more first HMI displays are presented in the one or more first panels of a multi-panel display at step 804. This could include, for example, the processing device 114 receiving the information from the touchscreen 206, retrieving HMI-related information for the HMI display(s) from a control system or other source(s), and presenting the HMI display(s) in the identified panel(s) of the multi-panel display 500.

During a pull operation, information identifying one or more second HMI displays is received from the touchscreen at step 806. One or more second HMI displays presented in the identified panel(s) are identified at step 808, and information identifying the one or more second HMI displays is transmitted to the touchscreen at step 810. This could include, for example, the processing device 114 identifying which HMI displays are currently being presented in the identified panel(s) 502-512 of the multi-panel display 500. This could also include the processing device 114 sending an identification of those HMI displays, data associated with those HMI displays, or other information related to the HMI displays to the processing device 402 of the touchscreen 206.

Although FIGS. 7 and 8 illustrate examples of methods 700 and 800 for managing navigation on an industrial operator console using a touchscreen, various changes may be made to FIGS. 7 and 8. For example, while shown as a series of steps, various steps in each figure could overlap, occur in parallel, occur in a different order, or occur any number of times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
presenting a representation of a multi-panel display of an operator console on a touchscreen separate from the multi-panel display, the representation including multiple placeholders associated with multiple panels of the multi-panel display;
receiving user input via the touchscreen, the user input identifying at least one of the placeholders associated with at least one of the panels and a desired function; and
performing the desired function to one of:
change first content presented in the at least one panel; or
change second content presented on the touchscreen based on the first content presented in the at least one panel.

2. The method of claim 1, wherein:
the desired function comprises pushing the first content to the at least one panel; and
performing the desired function comprises transmitting, to the operator console, information identifying one or more displays to be presented in the at least one panel.

3. The method of claim 2, wherein the one or more displays are currently presented on the touchscreen.

4. The method of claim 1, wherein:
the desired function comprises pulling the second content from the at least one panel; and
performing the desired function comprises receiving, from the operator console, information identifying one or more displays to be presented on the touchscreen.

5. The method of claim 1, wherein the user input comprises one or more gestures, different gestures associated with different desired functions.

6. The method of claim 1, wherein:
the panels of the multi-panel display are arranged in multiple rows and in multiple columns; and
the placeholders are arranged in the representation of the multi-panel display in the same number of rows and in the same number of columns.

7. The method of claim 1, wherein:
the operator console is associated with an industrial process control and automation system; and
the first and second content comprise human-machine interface (HMI) displays, each HMI display graphically representing at least a portion of one or more industrial processes.

8. The method of claim 7, further comprising:
receiving additional user input via the touchscreen, the additional user input associated with one or more of the HMI displays and modifying one or more controllers that control the one or more industrial processes.

9. An apparatus comprising:
a touch-sensitive display and at least one processing device;
wherein the at least one processing device is configured to present a representation of a multi-panel display of an operator console on the touch-sensitive display, the representation including multiple placeholders associated with multiple panels of the multi-panel display;
wherein the touch-sensitive display is configured to receive user input identifying at least one of the placeholders associated with at least one of the panels and a desired function; and
wherein the at least one processing device is configured to perform the desired function to one of:
change first content presented in the at least one panel; or
change second content presented on the touch-sensitive display based on the first content presented in the at least one panel.

10. The apparatus of claim 9, wherein:
the desired function comprises pushing the first content to the at least one panel; and
the at least one processing device is configured to initiate transmission to the operator console of information identifying one or more displays to be presented in the at least one panel.

11. The apparatus of claim 9, wherein:
the desired function comprises pulling the second content from the at least one panel; and
the at least one processing device is configured to receive from the operator console information identifying one or more displays to be presented on the touch-sensitive display.

12. The apparatus of claim 9, wherein:
the panels of the multi-panel display are arranged in multiple rows and in multiple columns; and
the placeholders are arranged in the representation of the multi-panel display in the same number of rows and in the same number of columns.

13. The apparatus of claim 9, wherein:
the operator console is associated with an industrial process control and automation system; and
the first and second content comprise human-machine interface (HMI) displays, each HMI display graphically representing at least a portion of one or more industrial processes.

14. The apparatus of claim 13, wherein:
the touch-sensitive display is configured to receive additional user input associated with one or more of the HMI displays; and
the at least one processing device is configured to modify one or more controllers that control the one or more industrial processes based on the additional user input.

15. A system comprising:
an operator console comprising at least one display device configured to present a multi-panel display to at least one user, the multi-panel display comprising multiple panels; and
a touchscreen device separate from the at least one display device, the touchscreen device configured to:
present a representation of the multi-panel display, the representation including multiple placeholders associated with the multiple panels of the multi-panel display;
receive user input identifying at least one of the placeholders associated with at least one of the panels and a desired function; and
perform the desired function to one of:
change first content presented in the at least one panel; or change second content presented on the touchscreen device based on the first content presented in the at least one panel.

16. The system of claim 15, wherein:
the desired function comprises pushing the first content to the at least one panel;
and the touchscreen device is configured to initiate transmission to the operator console of information identifying one or more displays to be presented in the at least one panel.

17. The system of claim 15, wherein:
the desired function comprises pulling the second content from the at least one panel; and
the at least one processing device is configured to receive from the operator console information identifying one or more displays to be presented on the touchscreen device.

18. The system of claim 15, wherein:
the panels of the multi-panel display are arranged in multiple rows and in multiple columns; and
the placeholders are arranged in the representation of the multi-panel display in the same number of rows and in the same number of columns.

19. The system of claim 15, wherein:
the operator console is associated with an industrial process control and automation system; and
the first and second content comprise human-machine interface (HMI) displays, each HMI display graphically representing at least a portion of one or more industrial processes.

20. A non-transitory computer readable medium containing instructions that, when executed by at least one processing device of a touchscreen separate from a multi-panel display of an operator console, causes the at least one processing device to:
present a representation of the multi-panel display on the touchscreen, the representation including multiple placeholders associated with multiple panels of the multi-panel display;
receive user input via the touchscreen, the user input identifying at least one of the placeholders associated with at least one of the panels and a desired function; and
perform the desired function to one of:
change first content presented in the at least one panel; or
change second content presented on the touchscreen based on the first content presented in the at least one panel.
